(19) United States
(12) Patent Application Publication
(10) Pub. No.: US 2021/0404944 A1
(43) Pub. Date: Dec. 30, 2021

(54) Evaporator and Climate Cabinet

(71) Applicant: Binder GmbH, Tuttlingen (DE)

(72) Inventors: Jochen Buschle, Nendingen (DE); Ludwig Renner, Mühlingen (DE)

(73) Assignee: Binder GmbH, Tuttlingen (DE)

(21) Appl. No.: 17/357,530

(22) Filed: Jun. 24, 2021

(30) Foreign Application Priority Data
Jun. 26, 2020 (DE) 10 2020 116 969.8

(51) Int. Cl. G01N 17/00; F25B 1/02; F25B 39/02; F25B 41/42; F25B 49/02

(52) U.S. Cl. CPC G01N 17/002; F25B 1/02; F25B 49/02; F25B 41/42; F25B 39/022

(57) ABSTRACT

An evaporator for a climate chamber, in particular for a constant climate chamber with temperature- and humidity control, comprising a first inlet, a second inlet and an outlet for a refrigerant, wherein the first inlet, the second inlet, and the outlet are connected with one another by a duct, and wherein the second inlet is disposed between the first inlet and the outlet, and a climate chamber with an evaporator.

### CROSS-REFERENCE TO RELATED APPLICATIONS

This application claims priority to German Patent Application No. 10 2020 116 969.8, filed Jun. 26, 2020, which is incorporated by reference in its entirety

### BACKGROUND

The present application relates to an evaporator for a climate chamber, in particular for a constant climate chamber, with temperature and humidity control having the features and structures recited herein.

### SUMMARY

In prior art climate chambers are known in various implementations and are employed in scientific laboratories or in the industry to simulate biological, chemical and/or physical environmental conditions such as, for example, temperature, atmospheric pressure and/or humidity. A climate chamber comprises an interior volume and a housing, wherein the interior volume is disposed within the housing and the biological, chemical, and/or physical environmental conditions are simulated within the interior volume.

Climate chambers known in prior art for cooling and dehumidifying the interior volume comprise a refrigeration circuit comprising a compressor that outputs a refrigerant in a closed circuit at the output side to a first heat exchanger that can release heat from the refrigeration circuit to the surroundings. The refrigerant is carried across a restrictor to the evaporator and at the input side back to the compressor. The evaporator is thermally coupled with the air in the interior volume whereby through the evaporation of the refrigerant heat can be withdrawn from the interior volume. When heat is withdrawn from the interior volume, the temperature can fall below the dew point and moisture from the interior volume can condense. The liquid medium resulting in this process can be drained from the interior volume.

In prior art, used for this purpose are evaporators, in particular plate evaporators, which comprise two separate zones for cooling and dehumidifying the air in the interior volume, wherein each of the zones comprises a single inlet and an outlet in order to effect the controlled cooling and/or dehumidification of the air in the interior volume.

The disadvantage entailed in this prior art has been that the entire surface area of the evaporators cannot be utilized for the cooling at maximum humidity. The temperature can fall below the dew point and the unintended dehumidification of the air can take place. Moreover, the conduction of the coolant between the compressor and the evaporator has been found to be complex and costly. The two outlets of the separate zones must first be merged in order to be subsequently connected at the input side to the compressor.

The present disclosure proposes a resolution to the above described problem.

The present disclosure addresses the problem of providing an improved evaporator for a climate chamber with cooling and dehumidification function that advantageously eliminates the disadvantages known in prior art.

This problem is resolved through an evaporator and a climate chamber having the features and structures recited herein.

The evaporator according to the application for a climate chamber, in particular for a constant climate chamber with temperature and humidity control, comprises a first inlet, a second inlet and an outlet for a refrigerant, wherein the first inlet, the second inlet and the outlet are connected by a duct and wherein the second inlet is disposed between the first inlet and the common outlet and opens out into the duct.

The present application is based on the concept of providing an evaporator that does not—in contrast to prior art—comprise two separate zones, but rather a single zone that can be utilized for the cooling. For the cooling over the entire evaporator a coolant can flow through the first inlet into the single-flow duct into the evaporator and again out of the outlet whereby, in contrast to prior known evaporators, at identical overall size a higher cooling capacity can be achieved since the entire evaporator is available for the cooling. Through the higher cooling capacity the difference between the dew point and the temperature in the interior volume can be kept small whereby unintended dehumidification of the interior volume in humidity mode can be avoided.

For the dehumidification, the evaporator has a second inlet which is disposed between the first inlet and the outlet through which additional coolant can be introduced into the duct. Through the additional introduction of coolant, the lowering of the temperature of the coolant mixture below the dew point of the air from the interior volume of the climate chamber can at least take place zone by zone whereby the moisture is condensed out and a condensate is generated that can be drained. The result is the dehumidification of the air in the interior volume of the climate chamber.

A further development provides for the duct to comprise a first end zone and a second end zone, for the first inlet to be disposed in the first end zone and the outlet to be disposed in the second end zone. It is especially preferred for the first inlet to form the first end zone of the duct and the outlet to form the second opposing end zone, whereby a coolant flowing in through the first inlet can flow through the entire duct.

According to a further provision, the duct can have a first line length L1 between the first inlet and the outlet and a second line length L2 between the second inlet and the outlet, wherein the first line length L1 is greater than the second line length L2, thus L1>L2. It is in particular preferred for the first line length L1 to be at least twice as large as the second line length L2, thus L1≥2·L2, wherein it is still further preferred if the following applies:

L1≥3·L2. Consequently, the stretch of way traversed by the coolant in the duct between the first inlet and the second inlet is greater than the subsequent stretch of way traversed by the flow between the second inlet and the common outlet.

A further development provides for the evaporator to be developed as a plate evaporator. The plate evaporator preferably comprises at least one special steel evaporator plate across which heat transfer can take place from the interior volume of a climate chamber into the refrigerant in the duct. Special steel has proven of value since this material has thermally, chemically as well as also mechanically stable surfaces.

The first inlet and the second inlet, the outlet and the duct can, furthermore, be disposed in a common plane whereby a compact plate evaporator is provided that can manifest as high a performance density as is feasible.

A further development of the evaporator provides for the evaporator to comprise a housing that encompasses the duct, wherein the duct is guided in the housing in meander form between the first inlet and the outlet. Due to the meander-form course of the duct in the housing, an area enlargement of the duct is attained whereby higher thermal flows can be achieved.

Furthermore, according to a further development, at least one diversion means can be provided in the housing by which the medium in the housing can be diverted. The at least one diversion means can determine the meander-form course of the duct, wherein preferably a multiplicity of diversion means is disposed in cascades. The diversion means can project into the housing alternatingly from opposite sides of the housing interdigitating in the form of combs wherein the duct is developed between two adjacent diversion means or between one diversion means and a wall of the housing.

Moreover, at least one free end of the at least one diversion means a diversion section can be developed at which a diversion of the coolant by preferably 180° takes place in the duct. The coolant flows in the particular diversion section at the input side on a first side of the plate-or web-form diversion means and, at the output side, on a second side, opposite to the first side, of the diversion means.

According to a further provision of the present disclosure, the second inlet can be disposed in a diversion section. In a preferred further development the second inlet can be disposed offset in the diversion section such that the coolant introduced through the second inlet is introduced at the output side into the diversion section.

According to a further development, several diversion means are disposed spaced apart, wherein a distance between the diversion means predetermines a cross section of the duct. It is in particular preferred for the diversion means to be disposed in parallel and spaced apart, wherein the distance between the diversion means, starting at the first inlet up to the outlet, can increase in order to take into account changes of the density of the coolant between the first inlet and the outlet.

In particular according to a further development of the present disclosure, a first duct cross section between the first inlet and the second inlet can be smaller than a second duct cross section between the second inlet and the common outlet in order to take into account the coolant flows that are added at the second inlet.

A further aspect of the present application relates to a climate chamber, in particular a constant climate chamber, with an interior volume and a refrigeration circuit configured for setting temperature and humidity in the interior volume, with a compressor and an evaporator, wherein the evaporator comprises a first inlet, a second inlet and an outlet for the refrigerant of the refrigeration circuit, wherein the first inlet, the second inlet and the common outlet are connected by a common duct, and wherein the second inlet opens out into the duct between the first inlet and the common outlet. The duct is preferably developed as a single-flow duct.

A further development of the climate chamber provides for the compressor to be connected at the input side with the outlet and, at the output side, to be connected in parallel with the first inlet and the second inlet of the evaporator.

At the output side between the compressor and the evaporator an air-cooled heat exchanger, in particular a fin-tube heat exchanger with axial fan, is preferably provided through which heat can be output to the surroundings of the climate chamber. It is furthermore preferred if between the compressor and the evaporator a filter, in particular a fixed-bed filter such as, for example, a dehydrator, is disposed before the refrigerant coming from the compressor at the output side is conducted to the parallel-connected first inlet and the second inlet, wherein at the first inlet and/or at the second inlet a valve, in particular an electromagnetic actuator, is provided through which a throughflow of the refrigerant to the first inlet and/or to the second inlet can be regulated. The valve, upstream of the first inlet and/or the second inlet, can as well serve for a corresponding flow restriction of the refrigeration circuit.

It has also been found to be advantageous if between the common outlet of the evaporator and the compressor a fluid filter is disposed.

A further development of the present application provides, moreover, for the compressor to be a piston compressor. Piston compressors can realize high compression ratios.

### BRIEF DESCRIPTION OF DRAWINGS

In the following an embodiment example of a refrigeration circuit of a climate chamber with an evaporator according to the present application will be described with reference to the accompanying drawing. Therein depict:

FIG. 1 a simplified and exemplary refrigeration circuit with an evaporator according to the patent application and

FIG. 2 a highly simplified, partially sectioned and perspective representation of an evaporator for a refrigeration circuit according to FIG. 1.

FIG. 3 a climate chamber.

### DETAILED DESCRIPTION

Like or functionally like structural parts are identified by like reference symbols. Furthermore, in the Figures not all like or functionally like structural parts are provided with a reference number.

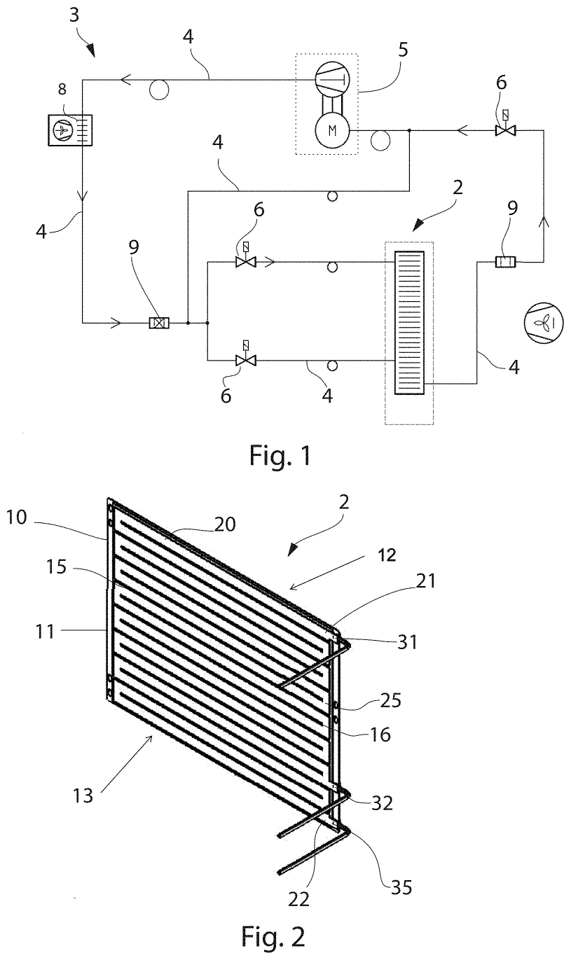

FIG. 1 shows an exemplary refrigeration circuit 3 of a climate chamber 1 comprising a compressor 5, a first heat exchanger 8, valves 6, an evaporator 2, and lines 4 that connect the components of the refrigeration circuit 3 with one another. The coolant coming from the compressor 5 at the output side is conducted across the line 4 to a heat exchanger 8. The heat exchanger 8 can output heat to the surroundings of the climate chamber 1 and, for this purpose, can be developed as a fin-tube heat exchanger with axial fan. Due to the heat output to the surroundings, the refrigerant can preferably be liquified. The line 4 connects across a T-branch the heat exchanger 8 with two parallel-connected valves 6 which, in turn, as will be described below, are connected with the evaporator 2. The evaporator 2 in the refrigeration circuit 3 is an expansion element as well as also a heat exchanger which can transfer heat from the interior volume 14 of the climate chamber 1 onto the refrigerant.

As is already evident based on the refrigeration circuit 3 according to FIG. 1, the evaporator 2 for the coolant comprises a first inlet 31 and a second inlet 32 as well as a common outlet 35, wherein the coolant flowing through the common outlet 35 as well as the coolant flowing through the first inlet 31 as well as also the coolant flowing through the second inlet 32 can flow out of the evaporator 2 again and be guided across line 4 at the input side to the compressor 5.

The first inlet 31 and the second inlet 32 are connected at the output side with the compressor 5, wherein the compressor 5 can be a piston compressor. The coolant coming from the compressor 5 is conducted across the T-branch to the parallel-connected first inlet 31 and second inlet 32, wherein upstream of each particular inlet 31, 32 one valve 6 is located which can regulate a coolant flow to each inlet 31, 32.

The refrigeration circuit 3 can furthermore comprise filters 9, wherein upstream of the T-branch or the valves 6 or the evaporator 2 a fixed-bed filter can be disposed and downstream of evaporator 2 a fluid filter can be disposed.

For control and regulation purposes, furthermore, a bypass can be provided which returns the refrigerant at the input side to the compressor 5 in front of the T-branch to valves 6.

Furthermore, a valve 6 can be disposed between the fluid filter 9 and the opening of the bypass on the input side of the compressor 5.

With reference to FIG. 2 it is evident that the evaporator 2 is developed as a plate evaporator with a housing 10, wherein the housing 10 can comprise a frame 11 and two plates 12, 13, which are disposed on opposing sides of the frame 11 and, together with the frame 11, can encompass a duct 20 in the interior of the housing 10 through which the coolant can flow from the first inlet 31 and the second inlet 32 to the common outlet 35. In the perspective representation according to FIG. 2 the plate 12 is not depicted.

The housing 10 or the plates 12, 13 can preferably be produced of special steel.

In the housing 10 a multiplicity of diversion means 15 are disposed in cascades whereby the duct 20 is developed in meander form in housing 10. The diversion means 15 are preferably connected with the plates 12, 13 such that they are liquid- and/or gas-tight and are furthermore disposed in parallel and spaced apart. The diversion means 15 project alternatingly from opposing sides and form at their free ends 16 a diversion section 25. For greater clarity only selected diversion means 15 and diversion sections 25 are provided with a reference number. In the diversion section 25 duct 20 is diverted by 180°, wherein the coolant is diverted by 180° in the diversion section 25 from an input-side duct section on a first side of the particular diversion means 15 about the free end 16 to a second side, opposite to the first side, of the particular diversion means 15 into an output-side duct section.

Duct 20 extends as a closed single-flow line from a first end zone 21 (in FIG. 2 upper right) as far as a second end zone 22 (in FIG. 2 lower right). In the first end zone 21 the first inlet 31 is disposed and in the second end zone 22 is disposed the common outlet 35, whereas the second inlet 32 opens out into duct 20 between the first inlet 31 and the common outlet 35.

A first stretch of way of duct 20 between the first inlet 31 and the second inlet 32 is of a first line length L1 and a second stretch of way between the second inlet 32 and the common outlet 35 is of a line length L2. As is directly evident in FIG. 2, the first line length L1 is considerably greater than the second line length L2.L1≥L2 preferably applies. In the depicted embodiment example L1≅4·L2.

The second inlet 32 also opens out into duct 20, whereby a refrigerant flow, conducted through the first inlet 31 into duct 20, can mix with a second refrigerant flow through the second inlet 32 and can be conducted jointly to the common outlet 35 through duct 20.

The second inlet 32 is disposed in one of the diversion sections 25, wherein the second inlet 32 is disposed in the diversion section 25 such that the second inlet 32 is oriented toward the output-side duct section of diversion section 25. It is, in particular, preferred if the second inlet 32 is oriented aligned to the output-side duct section.

In the first stretch of way of duct 20 between the first inlet 31 and the second inlet 32 the duct has a first duct cross section A1 which, according to the depicted embodiment example, is constant. However, the first duct cross section A1 can increase between the first inlet 31 and the second inlet 32, which increase can be realized, for example, thereby that the distance between the diversion means 15 increases with the goal of accounting for the density changes in the coolant so that the velocity of the coolants along the duct 20 between the first inlet 31 and the second inlet 32 is approximately constant.

A second duct cross section A2 can also be developed so as to be constant and can correspond to the first duct cross section A1; however, it is also feasible for the second duct cross section A2 to be dimensioned greater than the duct cross section A1. Through the second duct cross section A2 flows a coolant mass flow from the first inlet 31 as well as also a coolant mass flow from the second inlet 32, for which reason the second duct cross section A2 can be dimensioned greater than the first duct cross section A1 in order to attain a low flow rate due to the increased coolant mass flow.

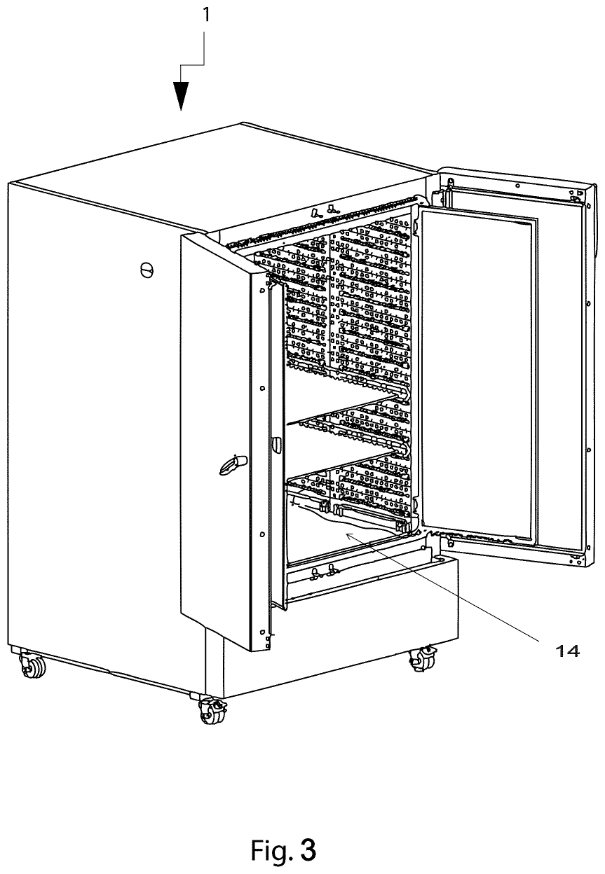

The climate chamber 1 shown in FIG. 3 is developed as a constant climate chamber and comprises cooling as well as also dehumidification functions, wherein in the interior volume 14 of the climate chamber 1 defined climate conditions can be set under the aspect of air humidity and temperature. Across the evaporator 2 heat can be withdrawn from the interior volume 14, wherein for the removal of heat from the interior volume 14 the refrigerant can flow through the first inlet 31 into the evaporator 2, and across the entire evaporator 2 a high cooling capacity can be achieved. In humidity operation of the climate chamber 1 a specific humidity value is to be set in the interior volume 14 of climate chamber 1, wherein it is advantageous for the difference between the dew point on one of the surfaces of the housing 10 of evaporator 2 and the temperature in the interior volume 14 of climate chamber 1 to be small in order to avoid unnecessary condensation on evaporator 2. In case dehumidification of the air mixture in the interior volume 14 of climate chamber 1 is to take place, further coolant can be introduced through the second inlet 32 into duct 20 whereby the temperature between the second inlet 32 and the common outlet 35 is lowered below the dew point, which is the reason the humidity condenses out on the evaporator plate and can be drained in the form of a liquid medium from the interior volume 14 of climate chamber 1.

### LIST OF REFERENCE SYMBOLS

1 Climate chamber

2 Evaporator

3 Refrigeration circuit

4 Line

5 Compressor

6 Valve

8 Heat exchanger

9 filter

10 Housing

11 Frame

12 Plate

13 Plate

14 Interior volume

15 Diversion means

16 Free end

20 Duct

21 First end zone

22 Second end zone

25 Diversion section

31 First inlet

32 Second inlet

35 Outlet

A1 First duct cross section

A2 Second duct cross section

L1 First line length

L2 Second line length

1. An evaporator for a climate chamber, comprising:
a temperature and humidity control,
a first inlet, a second inlet and an outlet for a refrigerant,
wherein the first inlet, the second inlet and the outlet are connected with one another by a duct, and
wherein the second inlet is disposed between the first inlet and the outlet.

2. The evaporator as in claim 1, wherein the duct comprises a first end zone and a second end zone and that the first inlet is disposed in the first end zone and the outlet is disposed in the second end zone.

3. The evaporator as in claim 1, wherein the duct has a first line length between the first inlet and the outlet and a second line length between the second inlet and the outlet, wherein the second line length is less than the first line length.

4. The evaporator as in claim 1, wherein the evaporator is developed as a plate evaporator.

5. The evaporator as in claim 1, wherein the first inlet, the second inlet, the outlet and the duct are disposed in a common plane.

6. The evaporator as in claim 1, further comprising:
a frame; and
two plates, wherein the two plates are disposed on opposing sides of the frame and wherein the frame and two plates encompass the duct and that the duct is guided in meander form between the two plates.

7. The evaporator as in claim 1, wherein the duct is formed by diversion projections alternatingly projecting from opposing sides of the frame.

8. The evaporator as in claim 1, wherein the diversion projections are disposed spaced apart from one another.

9. The evaporator as in claim 1, wherein at a free end of at least one of the at least one diversion provisions a diversion section is disposed.

10. The evaporator as in claim 1, wherein the second inlet is disposed in a diversion section.

11. The evaporator as in claim 1, wherein a duct cross section between the first inlet and the second inlet is less than a second duct cross section between the second inlet and the outlet.

12. A climate chamber, comprising:
a temperature and humidity control that provides a constant climate chamber,
a first inlet, a second inlet and an outlet for a refrigerant,
wherein the first inlet, the second inlet and the outlet are connected with one another by a duct,
wherein the second inlet is disposed between the first inlet and the outlet,
wherein the climate chamber has an interior volume and a refrigeration circuit,
configured for setting temperature and humidity in the interior volume, with a compressor and an evaporator.

13. The climate chamber as in claim 12, wherein the compressor is connected at a compressor input side with the outlet and at a compressor output side is connected in parallel with the first inlet and the second inlet.

14. The climate chamber as in claim 12, wherein the compressor is a piston compressor.
